(19) United States
(12) Patent Application Publication
(10) Pub. No.: US 2024/0198723 A1
(43) Pub. Date: Jun. 20, 2024

(54) Traction Enhancement and Improved Spokes for Airless Tires

(71) Applicants: Shi-En Shiau, Scottsdale, AZ (US); Brian Chia-Huan Shiau, Scottsdale, AZ (US)

(72) Inventors: Shi-En Shiau, Scottsdale, AZ (US); Brian Chia-Huan Shiau, Scottsdale, AZ (US)

(21) Appl. No.: 17/758,354

(22) PCT Filed: Feb. 8, 2022
(86) PCT No.: PCT/US22/15630

§ 371 Date: Jul. 4, 2022

Related U.S. Application Data
(60) Provisional application No. 63/360,313, filed on Sep. 24, 2021.

(51) Int. Cl. B60B 9/28; B60B 19/06

(52) U.S. Cl. CPC B60B 9/28; B60B 19/06; B60B 2900/551

(57) ABSTRACT

The invention is embodied in a tire having retractable studs. A driver can activate the studs for driving in icy and/or snowy conditions without manual replacement of all-weather tires to snow or studded tires as well as the installation of snow chains.

The invention can be incorporated in an airless tire vehicle's traction control system and anti-lock brake system (ABS), which the traction control system can activate the retractable studs to add traction on one or more wheels. In addition, this invention provides a better thermal dissipation for airless tires.

### FIELD OF THE INVENTION

The present invention relates to airless tires. More specifically, this invention relates to traction enhancement and improved spokes for airless tires.

### BACKGROUND

Anti-lock brake systems (ABS) have greatly reduced the frequency and magnitude of vehicle accidents. However, there is room for improvement with respect to vehicle braking during emergency conditions. A skidding wheel (where the tire contact patch is sliding relative to the road) has less traction than a non-skidding wheel. ABS works with the vehicle's traction control system for on-off and reduced brake control, but it does not change the physical contact (traction) with the pavement.

As winter rolls in and road conditions worsen, the traffic accidents and fatality increase. Accidents on icy roads in the US are responsible for an average of 1,836 deaths and 136,309 injuries per year. Ice and snow make slippery roads. The action of tires spinning and sliding on snow and ice greatly decreases traction on hazardous road surfaces.

There are several ways that one can prepare oneself to help safely navigate icy roads. One can switch to snow tires every winter. In addition, metal studs (FIGS. 1,2, and 3) can be inserted to snow tires for additional traction.

Snow chains (FIG. 4) are another way to get better traction on icy roads. With snow chains, it limits the driving speed of around 30 miles per hour. However, the snow chains cause a bumpy ride, damage roadways and cause fuel inefficiency once the pavements are cleared.

Metal tire studs are banned in some areas or are limited to certain conditions and/or specific time periods because they damage roads.

Since the early 1970s, many studies throughout the U.S. and internationally noted that studded tires increase traction on icy surfaces, but may not offer any safety advantages in comparison to modern radial winter tires in non-icy road conditions. However, many studies also noted the less friction of the studded to studless was due to the friction nature of softer all weather tires larger than hard rubber of studded tires. The studs did not decrease tire-road friction.

The studs penetrate both asphalt and concrete pavement—In June 2010, Washington State Department of Transportation in cooperation with U.S. Department of Transportation Federal Highway Administration June 2010 conducted a study on Studded Tire Wear on Portland Cement Concrete Pavement in the Washington State Department of Transportation Route Network. The study documented highway pavement from stud rutting, a track worn by a wheel or by habitual passage.

The studded and studless on the same material and tread design tires—In October 2015, The Norwegian Automobile Federation tested Studded Tires and studless tires from 12 tire manufacturers on Winter Dry and Wet Pavement. The stud provided by stud manufactures were added to tires provided by the tire manufacturers. The studded tires consistently outperformed the studless tires in wet and dry categories of both braking and handling, despite the presence of studs.

The reputation that studded tires have poor performance on dry and wet pavement is probably a remnant of a time when the only true winter tires most people had experienced were hard rubber studded tires that were compared to weather tires using softer rubber and a more flexible tread design.

Currently, all passenger cars are equipped with pneumatic tires (FIGS. 5 and 6), which must be ensured with proper air in at the manufacturers' design air pressure. Failing to do so causes premature wear on the tire and can lead to blowouts, a very unpleasant and nuisance experience to too many drivers. To avoid complication of neglectful car owners, tire manufacturers have been developing designs for tires that don't use air at all and may roll out airless tires (FIG. 7) for passenger cars in 2024.

Airless tires are often filled with compressed polymers (plastic), rather than air or can be a solid molded product. Speed limitations and rider uncomfortableness are two sticking points to the tire designed. Contrary to the pneumatic tires that can dissipate heat to the contained air in the tire, compressed polymer-filled airless tire accumulates heat, which reduces driving speeds in order to avoid damaging the rubber tire.

Airless tires do not have a tire blowout problem. However, highway speeds and heat are often common factors in tread-belt separations allowing the tread-belt to peel away from the body of the tire. Improvements have been made with the introduction of plastic spokes that can bend, provide a smoother ride, provide better air exposure for the rubber tire, and eliminate tire blowouts. But these spoke improvements have not solved the heat/tread-belt separation issue. On the negative side, the spokes tend to accumulate debris and impact the tire's performance in providing a comfortable ride. The spokes may also weaken through time and result increased pavement contact that impacts the fuel efficiency and speed.

### SUMMARY OF INVENTION

The invention can be incorporated into a wheel for enhanced traction. Broadly, the wheel comprises a center hub that houses a pressure generating assembly. Extending radially from the exterior face of the center hub are a plurality of extendible stud spokes. The proximal end of each extendible stud spoke is in fluid communication with the pressure generating assembly. The distal end of each extendible stud spoke is connected to a tire.

The pressure generating assembly delivers pressurized fluid to each extendible stud spoke. Housed inside each extendible stud spoke is a sliding stud that slides within the extendible stud spoke in response to fluid pressure. In an extended position, the sliding stud extends beyond the face of the tire. In a retracted position, the sliding stud does not extend beyond the face of the tire. In one embodiment a vehicle's traction control system and/or anti-lock brake system (ABS) can control the pressure delivered to the extendible stud spokes so that the sliding studs can be extended automatically. In another embodiment, a driver can manually control the pressure and extend the studs when driving in icy and/or snowy conditions.

The sliding studs preferably have at least two extended positions and sizes. The shorter and smaller bead head is for icy conditions and during the activation by the tract control system, while the longer and larger rod is for snowy conditions. (FIG. 23)

When extended studs are not needed or desired, the sliding studs can be recessed within the wheel for a smooth drive and so they do not damage the roadway pavement and/or the stud itself.

In addition to housing a sliding stud, the extendible stud spokes can also comprise a spring that acts like a shock absorber for airless tire pavement contact patch. The spring enables a smoother ride and full patch traction like pneumatic tires. The spring also operates to retract the sliding stud when the pressure on the proximal side of the sliding stud is reduced enough. Optionally, some of the spokes may not comprise sliding studs. The non-extendible stud spokes can help smooth the ride.

The preferred pressure generating assembly comprises a pressurized air tank for supplying pressure to the extendible stud via a conduit system. The conduit system can be created in many ways, but it is preferred to use a circular manifold and lateral distribution pipes to distribute pressurized fluid to the extendible stud spokes. It is also preferred to add a motorized valve, a pressure reducing valve and an air to oil pressure booster to the conduit system between the pressurized air tank and the first end of the extendible stud spoke in order to control the pressure delivered to the extendible stud spoke.

The preferred embodiment employs a magnetic DC generator to create electrical power for charging a battery. The generator is preferably located in the center hub and its gear meshes with a gear mounted to an extension of the axle so that the turning wheel can power the generator and charge the battery. The battery can power electronic devices as discussed below.

Among other things, this invention provides (1) better thermal dissipation for airless tires, (2) smoother and better ridership, (3) enhances tire traction in conjunction with the vehicle's ABS and tract control system, and (4) the convenience of quipping the airless tire with studs on demand in icy and/or snowy weather without having to manually replace all weather tires, snow tires, studded tires, or having to add snow chains.

This invention enables tires that use softer rubber and flexible tread design with hidden stud. The studs are recessed in the tire will not cause pavement rutting in normal driving conditions, the activation by the ABS would be expected to limit the pavement impact area less than 80′ long.

### LIST OF DRAWINGS

FIG. 1 illustrates a sample of studded tires;

FIG. 2 illustrates a sample of built in studded installations;

FIG. 3 illustrates a sample of insert style stud;

FIG. 4 illustrates a sample of tires on snow chains;

FIG. 5 illustrates terminologies of a sample of a pneumatic tire;

FIG. 6 illustrates a sample of a pneumatic tire structure;

FIG. 7 illustrates a prototype spoke airless tire being commercially developed;

FIG. 8 illustrates the embodiment mechanical and process chart;

FIG. 9A illustrates a hub embodiment;

FIG. 9B illustrates a cover cap embodiment;

FIG. 10A illustrates an embodiment of a pressure generating assembly;

FIG. 10B illustrates a pipe system embodiment;

FIG. 11 illustrates an extendible axel mounted magnetic DC generator;

FIGS. 12A and 12B illustrate an embodiment of a mechanical spacer inserted in the center hub;

FIG. 13 illustrates a centric spinning air compressor;

FIG. 14 illustrates the preferred embodiment of the stud system;

FIG. 15 illustrates pressure conversion;

FIG. 16 illustrates an air-to-hydraulic pressure booster;

FIG. 17 illustrates an embodiment of air piping and controls;

FIG. 18 illustrates an embodiment of stud placement (cross section of a tire);

FIG. 19 illustrates an embodiment of stud device details;

FIG. 20 illustrates an embodiment of intermediate spoke details;

FIG. 21 illustrates an embodiment of spring loading and length;

FIGS. 22A-E illustrate pavement-tire interaction scenarios and embodiments;

FIGS. 23A-D illustrate various applications of the extendible stud;

FIG. 24 illustrates a conduit system; and,

FIG. 25 illustrates a locking device of the spring housing and the stud shaft housing.

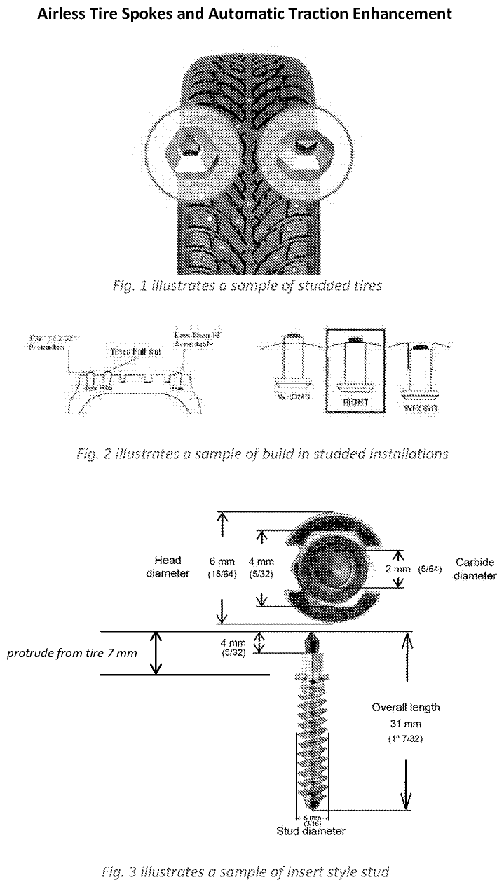

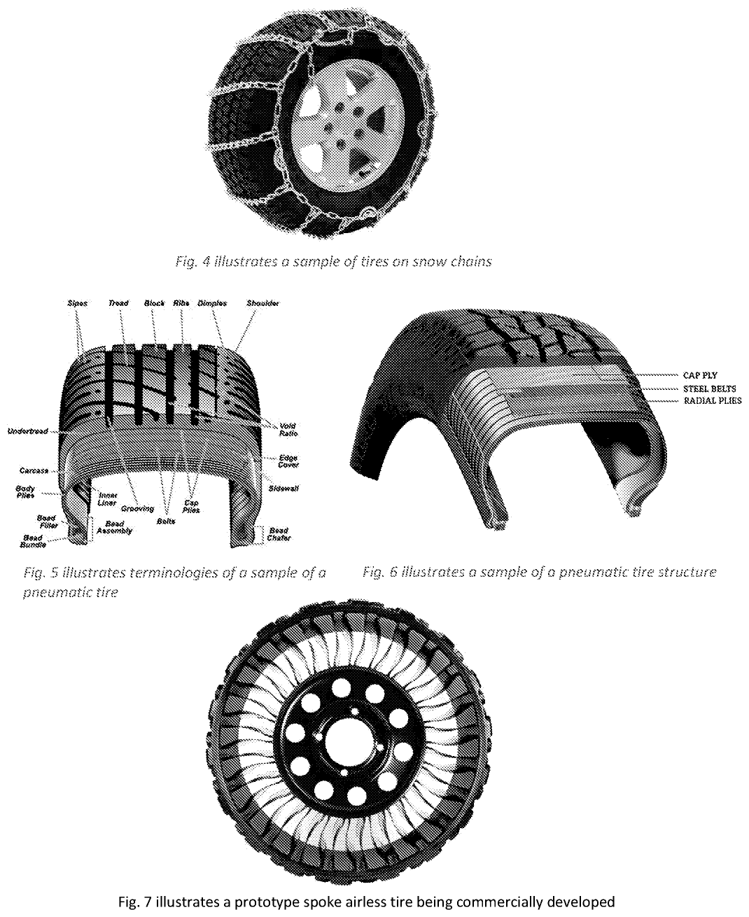

### DETAILED DESCRIPTION OF THE PREFERRED EMBODIMENTS

A clear understanding of the key features of the invention is referenced to the appended drawings that illustrate the invention. It should be understood that such drawings depict preferred embodiments of the invention and, therefore, are not to be considered as limiting its scope regarding other embodiments that the invention is capable of contemplating.

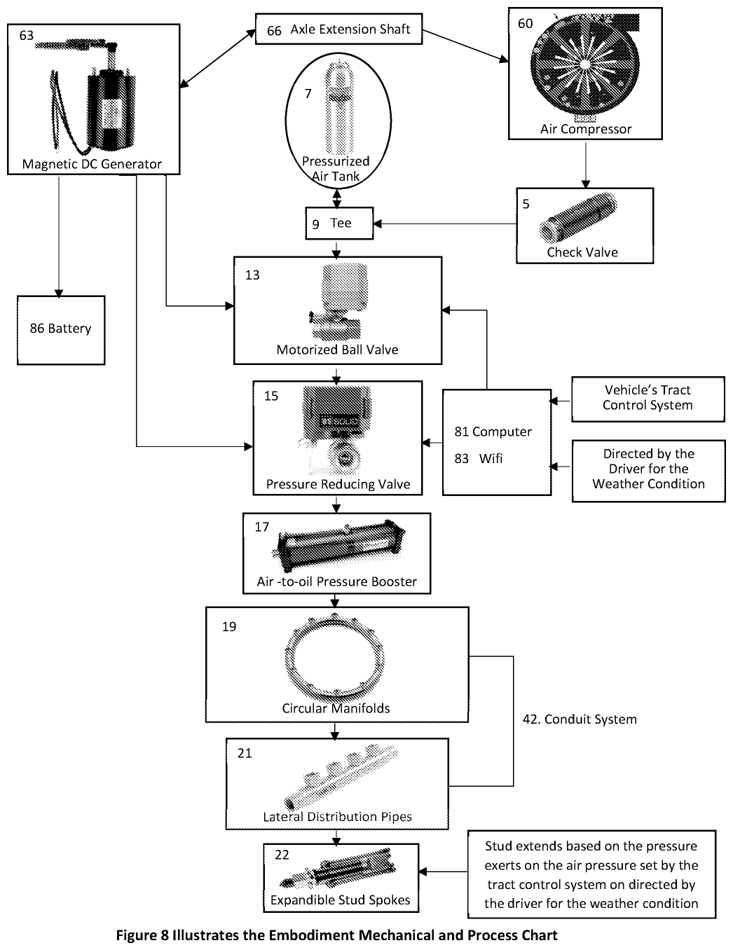

The invention is embodied in a built-in stud system. The system is preferably axle driven and self-powered. The invention is an on demand wheel traction enhancement that can be operated by the traction control system (or “tract” system) and/or the anti-lock braking system (“ABS”). It also adds safety enhancements similar to mounting snow chains and/or replacing all weather tires with studded snow tires as needed. The preferred embodiment of the invention is shown in FIGS. 8, 10, and 14.

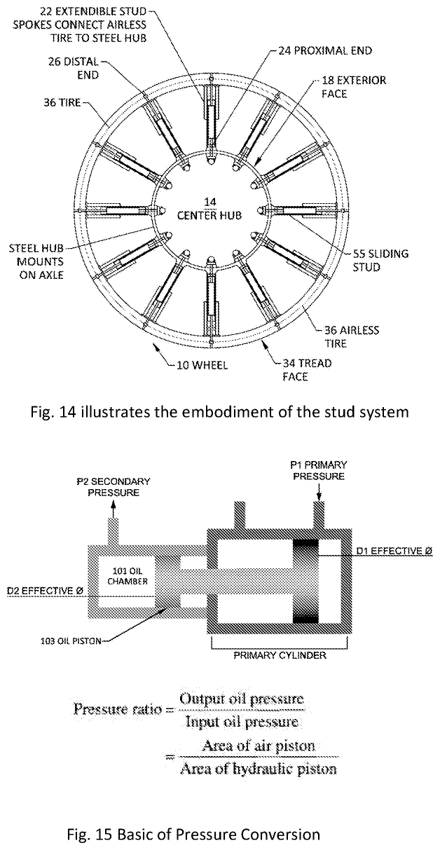

FIG. 14 illustrates a wheel 10 for enhanced traction. The wheel 10 comprises a center hub 14 that houses a pressure generating assembly 16 (FIG. 10A). Extending radially from the exterior face 18 of the center hub 14 are a plurality of extendible stud spokes 22. The proximal end 24 of each extendible stud spoke 22 is in fluid communication with the pressure generating assembly 16. The distal end 26 of each extendible stud spoke 22 is connected to a tire 36.

The pressure generating assembly 16 delivers pressurized fluid to each extendible stud spoke 22. Housed inside each extendible stud spoke 22 is a sliding stud 55. The sliding stud 55 can be positioned inside the extendible stud spoke so that it can extend beyond the tread face 34 of the tire 36 and enhance traction depending on the pressure delivered to the extendible stud spoke. The pressure generating assembly 16 can be connected to and controlled by a vehicle's traction control system and/or anti-lock brake system (ABS) so that the studs can be extended automatically as the driving environment dictates. Alternatively, a driver could manually control the pressure and extend the studs when driving in icy and/or snowy conditions.

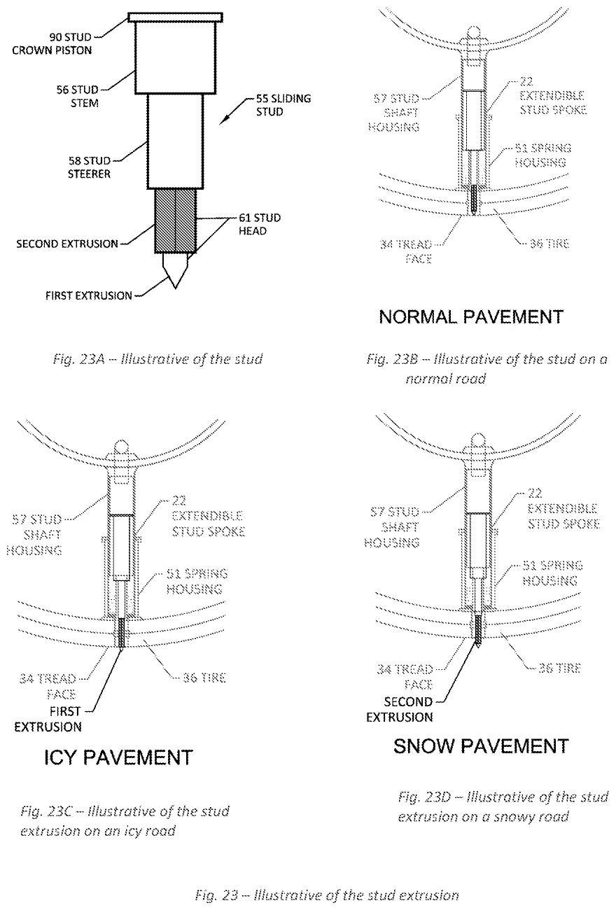

When extended studs are not needed or desired, the stud heads 61 (FIG. 23B) are recessed within the wheel (so that they do not extend past the tread face 34 for a smoother ride and to prevent damage the roadway pavement and/or the stud itself).

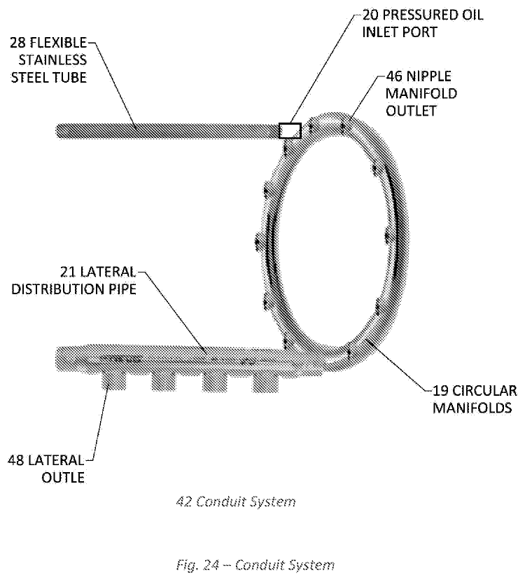

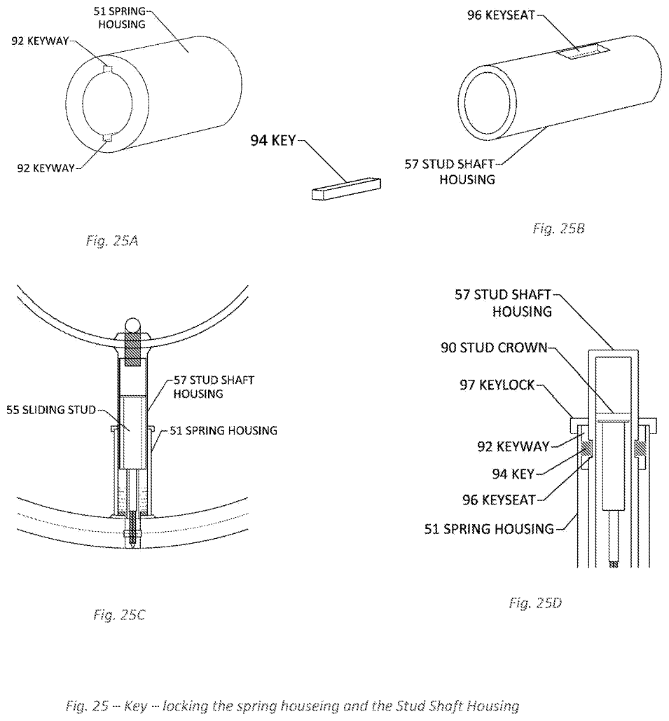

Turning now to FIGS. 10A and 10B, the preferred pressure generating assembly 16 comprises a pressurized air tank 7 for supplying pressure to the extendible stud spokes 22 via a conduit system 42 (FIG. 24). The conduit system 42 can be created in many ways, but it is preferred to use a circular manifold 19 and lateral distribution pipes 21 to distribute pressurized fluid. Similarly, it is preferred to connect a motorized valve 13, pressure reducing valve 15 and an air to oil pressure booster 17 (FIG. 17) to the conduit system 42 between the pressurized air tank 7 and the first end of the stud spoke in order to modify the pressure to the spoke.

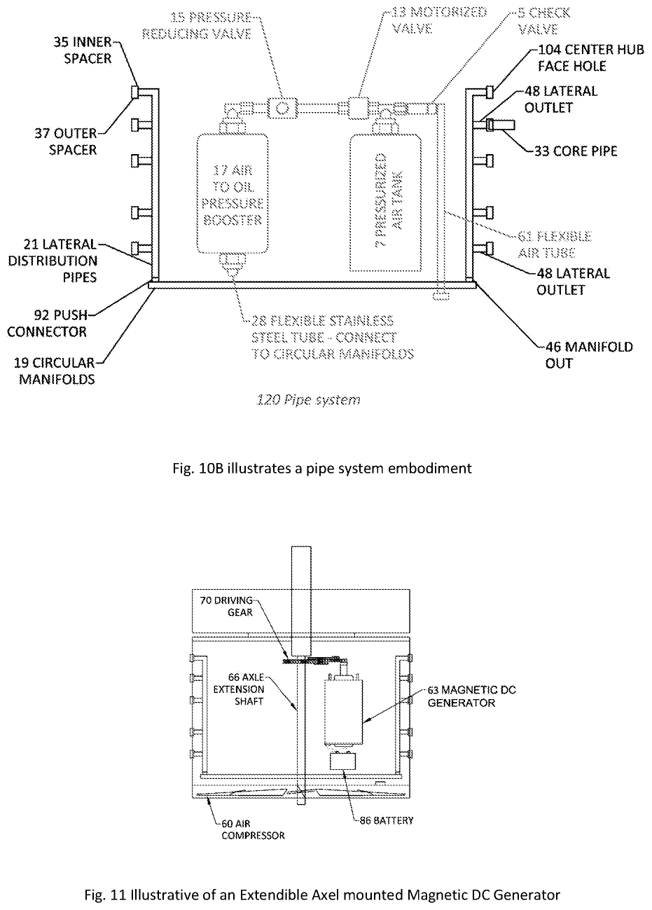

The preferred embodiment of the wheel employs an air compressor 60 mounted on the center hub 14 to pressurize the air tank 7. In addition, the preferred embodiment employs a magnetic DC generator 63 to create electrical power (FIG. 11).

### The Preferred Center Hub 14

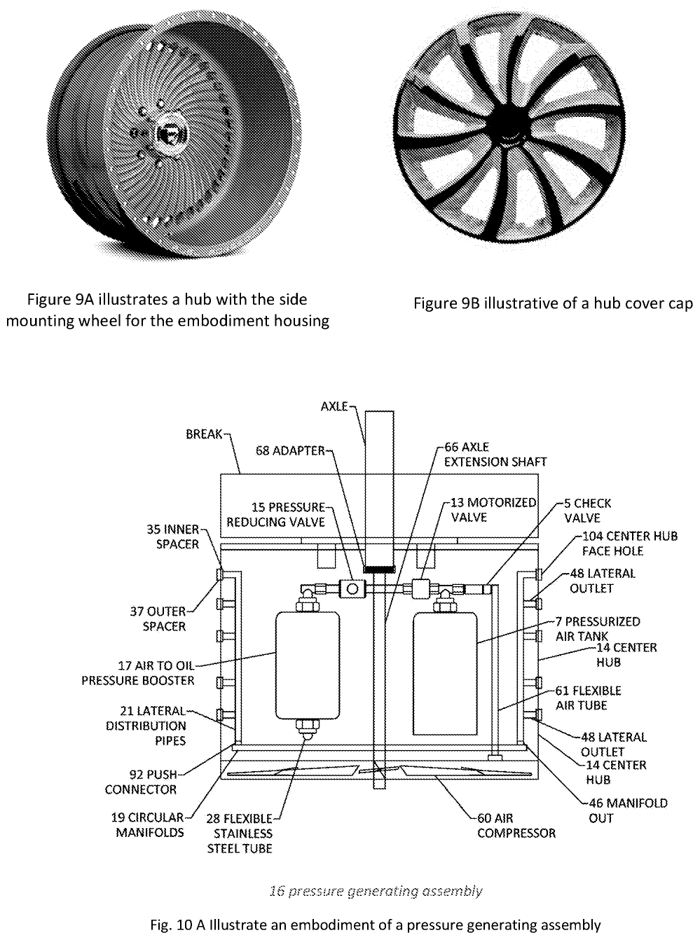

The preferred center hub 14 is shown in FIG. 9A. The preferred center hub 14 is a side mount wheel rim that can be covered with a rim cap. As shown in FIG. 10, an OEM long axel or an axle extension shaft 66 can be added to the side mound wheel rim. The preferred axle extension shaft 66 is not load-bearing. The principal purpose of the axle extension shaft 66 is to serve as a mount for the air compressor 60 and the magnetic DC generator 63. Typically, the axle extension shaft 66 would be ½″ diameter. An axel adapter 68 (FIG. 10) can lock the axle extension shaft 66 to the vehicle's axle on one end. The fastener of the axle adapter 68 should be able to be unscrewed and released from the peeking hole on the rim. The other end of the axle extension shaft 66 can have a hexagon end that can fasten to the rim cover's built-in air compressor 60 (FIGS. 8 and 10) to maintain the axle extension shaft 66 level and to minimize vibration.

A driving gear 70 (FIG. 11) can be mounted on the axle extension shaft 66 (FIG. 11) to drive a permanent magnet DC generator 63 (FIGS. 8 and 11). The gear tooth ratio of the driving gear 70 over the motor gear times the vehicle's axle rpm for all driving speed should be within the motor's rpm range. The electricity generated charges the battery 86.

The battery 86 powers the WIFI 83 communications with the vehicle's tract control system, the driver dashboard, and equipment enclosed in the center hub including the onboard computer, various on/off valves, and pressure reducing and releasing valves.

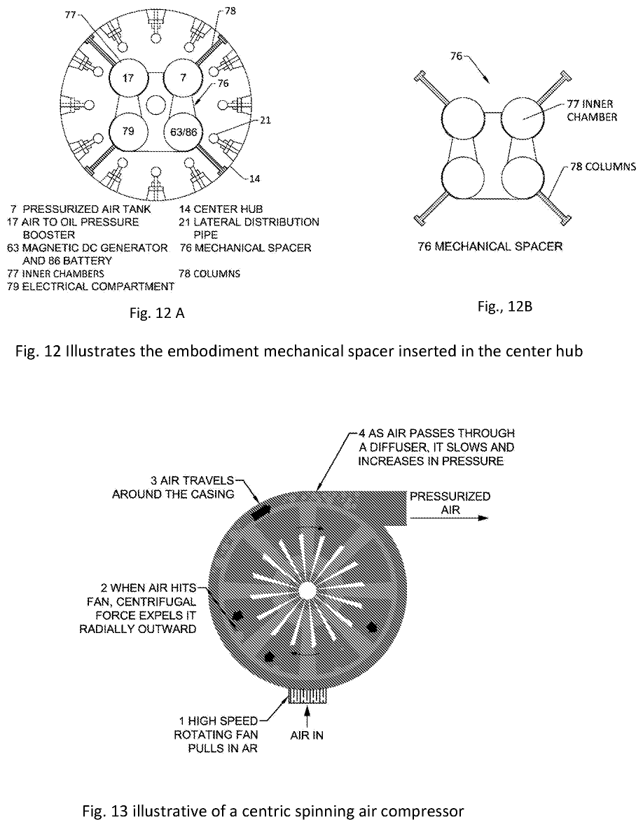

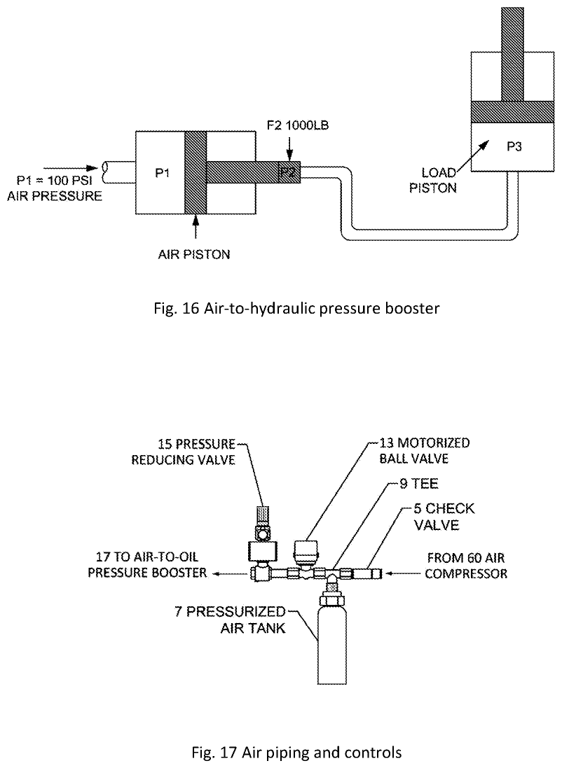

A mechanical spacer 76 (FIG. 12) can house the magnetic electric generator 63, the air tank 7 (FIGS. 8 and 10), an electronic compartment 79 (computer 81, WIFI 83, and battery 86) (FIG. 12), and the air-to-oil pressure booster 17 (FIG. 12, FIG. 8, and FIG. 16). The mechanical spacer 76 ensures that all components do not impede the installing and/or removing the wheel lugs.

The mechanical spacer 76 fits inside the center hub 14. The mechanical spacer 76 preferably has a plurality of inner chambers 77 to house items. In addition, the mechanical spacer 76 has a plurality of columns 78 that bear against the inside face of the center hub 14 and hold the plurality of chambers fixed inside the center hub 14.

The preferred air compressor 60 is a centric air compressor (FIGS. 8 and 13) that is spun by the rotating axle shaft and can generate compressed air up to 150 psi. Compressed air from the compressor 60 is preferably connected to an inline check valve 5 with a flexible air tube 61 (FIG. 10B) prior to entering the air tank 7 (FIGS. 8 and 17). The inline check valve 5 prevents backflow from the air tank when the air compressor is not in operation while the vehicle is not in motion.

A tee 9 and motorized valve 13 can be used to control the release of pressure into the conduit system 42. It is also preferred to employ a pressure reducing valve 15 prior to the air-to-oil pressure booster 17 (FIGS. 8, 10, and 17). The preferred motorized valve 13 is an on-off ball valve (FIGS. 8, 10 and 17) and the preferred pressure reducing valve 15 is a remote controlled two-preset and one limit air pressure reducing valve (FIGS. 8, 10 and 17). Alternatively, a similar configuration can be replaced by a tee 9 with parallel outlet each connecting to a pre-set pressure control valve followed by a reverse parallel tee that joins with a single tube connecting to the air-to-oil pressure booster 17.

The air pressure tank 7 provides a stable and ready pressurized air volume for the need of the air-to-oil booster 17. The air-to-oil pressure booster 17 can be in two cylinders or one unit with two chambers based on the space design as shown on FIG. 15 and FIG. 16 to boost the inflow air pressure from the compressed air vessel to the target oil pressures.

Turning now to FIG. 15, the oil chamber 101 must have sufficient volume of the oil for moving the studs to the target position. The minimum oil volume in the chamber=the number of studs * stud extendible length * cross area of stud crown piston 90, where the oil piston 103 (hydraulic piston) can operate and move freely in the oil chamber.

The outlet of the air-to-oil pressure booster 17 is preferably connected to a circular shaped distribution head manifold (the circular manifold 19) (FIGS. 8 and 10B) with a flexible stainless tube steel 28. In addition to the manifold outlet for connection to the air-to-oil pressure booster, the preferred circular manifold 19 has a plurality of equally spaced 90° nipple manifold outlets 46. The number of outlets 46 matches the number of the cross lines of studs on the airless tire (typical snow chains has 12 to 14 runs over the ground when secured on a tire (FIG. 14).

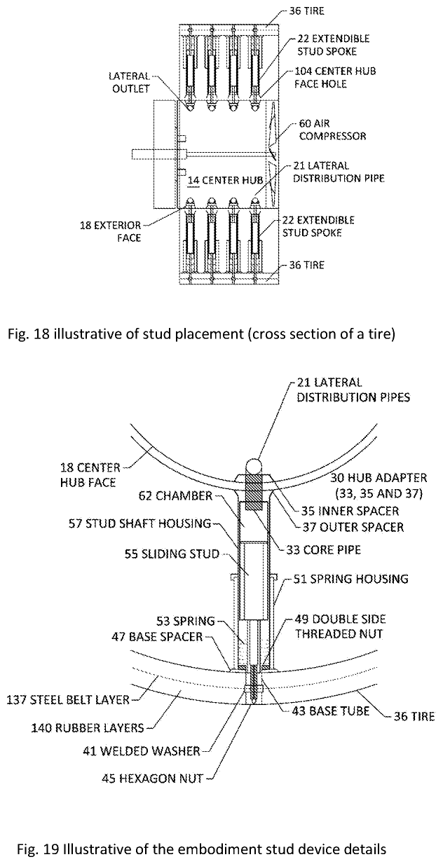

Each of the manifold outlets 46 is preferably connected to a lateral distribution pipe 21 (FIGS. 8, 10 and 24) through push connectors 92. The lateral distribution pipes 21 have a plurality of spaced 90° lateral outlets 48 (FIGS. 18, 19, and 24), typical tire trade has 4 grooves, that line-up with the center hub face hole 104 for connection to the proximal end 24 of the extendible stud spoke 22.

### The Preferred Extendible Stud Spoke

FIGS. 8, 14, 18, and 19 illustrate the preferred extendible stud spoke 22 and its connections to the center hub face 18 on the proximal end 24 and the tire 36 on the distal end 26. On the proximal end 24, it is preferred to use a hub adapter 30. As shown on FIG. 19, hub adapter 30 has three parts: a core pipe 33, an inner spacer 35, and an outer spacer 37.

The core pipe 33 is connected to a lateral outlet 48 of the lateral distribution pipe 21. The core pipe 33 runs from the lateral outlet 48 through the center hub face 18 and into the interior of the extendible stud spoke 22. As fluid pressure inside the extendible stud spoke 22 increases, the force distally pushing the stud crown piston 90 of the sliding stud 55 increases. Each lateral outlet 48 connects to a center hub face adapter 30 fastened over the center hub face hole 104. See, FIGS. 10B and 14.

The inner spacer 35 and outer spacer 37 are used to secure the proximal end 24 of the extendible stud spoke 22 to the center hub face 18. The preferred inner spacer 35 has a convex bottom surface matching the inner circumference of the center hub face 18 with a flat top. The preferred outer spacer 37 has a concave bottom matching the outer circumference of the center hub face 18 with a flat top. Both spacers' diameters are preferably not smaller than three times of the core pipe's diameter. The length of the core pipe 33 should have at least ½″ extra length with external threads where nuts can secure the lateral distribution pipe 21, the inner spacer 35 and the outer spacer 37 to the center hub face 18. It is preferred to weld the inner spacer 35 and the core pipe 33 to each outlet 48 of the lateral distribution pipe 21. A nut fastens the core pipe 33 and the outer spacer 37 on the tire side. Outer spacer 37 should have external threads matching the inner diameter of the stud shaft housing 57 for the installation of the stud shaft housing.

The extendible stud spoke 22 is positioned between the center hub 14 and the tire 36. As shown in FIG. 19, the preferred extendible stud spoke 22 comprises several parts, including a stud shaft housing 57, a sliding stud 55, a spring housing 51 and a spring 53.

Turning to FIG. 19, the stud shaft housing 57 partially houses the sliding stud 55 and allows the sliding stud to move within the stud shaft housing 57. The spring housing 51 mates with the stud shaft housing 57 and also partially houses the sliding stud 55. The stud shaft housing 57 is connected on the proximal end to the outer spacer 37. The spring housing 51 is connected on the distal end to the tire 36. A spring 53 is positioned within the spring housing 51 to bias the sliding stud 55 in the proximal direction. The net force of the hydraulics pressure and the spring's compression stress exert on the sliding stud 55 that enables the sliding movement of the stud shaft.

It is preferred to mate the stud shaft housing 57 with the spring housing 51 via a slidable connection. As shown in FIG. 25, the stud shaft housing 57 has an outside diameter that permits it to slide into the spring housing 51. In order to limit this slidable connection, a keyway system can be employed. FIG. 25 illustrates one embodiment of this slidability limiter.

In this preferred embodiment, the stud shaft housing 57 has two exterior keyseats 96 (FIG. 25), preferably positioned on opposing sides. A key 94 is configured to fit within a keyseat 96. Two keyways 92 are positioned on the inside face of the spring housing 51. The length of the keyways 92 is selected to limit the relative movement between the stud shaft housing 57 and the spring housing 51. The key 94 can move along the length of the keyway 92. A keylock 97 stops the key 94 on the proximal end and the end of the keyway 92 stops the key on the distal end.

The keyways 92 of the spring housing 51 and the keys 94 of the stud shaft housing 57, the keylock 97, the stud shaft crown piston 90, the limiting diameter of the stud shaft housing and the base double side threaded connections 49 secure the extendible stud spoke 22 to the hub and the tire. It locks the tire to the hub even if the tire is broken off a running vehicle. It also limits the recess of the extendible stud spoke should the oil boosted hydraulic pressure fail. Hence, minimizes failed tire hazard.

The stud shaft housing 57 preferably has internal female threads for fastening to the outer spacer 37. Referring to FIG. 23A, the stud shaft housing 57 should have an inside diameter matching diameter of the stud crown piston 90 or slightly bigger to allow movement. The spring housing 51 has an inner diameter matching the external diameter of the stud shaft housing 57 for longitudinal movement to the hub side or the tire side.

Turning to FIG. 23A, the one-piece sliding stud 55 comprises a stud crown piston 90, the stud stem 56, the stud steerer 58, and the stud head 61. The stud crown piston 90 has a diameter slightly smaller than the inside diameter of the stud shaft housing 57. The stud stem 56 has a diameter slightly smaller than the spring housing 51. It is preferred to position an o-ring (e.g., an IP67 dynamic o-ring) between the stud stem 56 and the inside face of the spring housing 51 for sealing the oil enclosure The stud steerer 58 has a diameter slightly smaller than the spring's inner opening diameter. The stud head has a maximum diameter slightly smaller than the internal diameter of the base tube 43.

The stud stem 56 is sized to fit tightly, but slidably within the stud shaft housing 57. A chamber 62 is created by the space between the proximal face 64 of stud shaft crown piston 90 and the proximal end of the stud shaft housing 57. Fluid is delivered into the chamber 62 within the stud shaft housing 57 via the core pipe 33. As fluid pressure inside the chamber 62 increases, the pressure pushes against the proximal face of the stud shaft crown piston 90, which tends to move the stud in a distal direction. The spring 53 is positioned on the distal side of the sliding stud 55 and, when compressed, creates an opposite force on the sliding stud shaft. This opposite force pushes the sliding stud 55 proximally toward the center of the wheel 10.

The distal end 26 of the extendible stud spoke 22 is connected to the tire 36. The preferred tire 36 has at least two layers: a steel belt layer 137 and a rubber layer 140 as shown in FIG. 19. The spring housing 51 is preferably connected to the steel belt layer 137 of the tire 36 via a threaded connection. In the preferred embodiment, a base tube 43 passes through the tire 36 (see FIG. 19). The base tube 43 is secured to the steel belt layer 137 on the proximal side by a double sided threaded nut 49. The base tube 43 is secured to the distal side of the steel belt layer by a hexagon nut 45. It is preferred to add base spacer 47 between the double sided threaded nut 49 and the steel belt layer 137. It is also preferred to weld washers 41 to the distal side of the steel belt layer 137 for the base tube 43 to pass through. A thermal press procedure is preferred, but other known methods would be suitable.

The double sided threaded nut 49 also secures the spring housing 51 to the proximal face of the tire 36, where the outer thread fastens the spring housing 51 and the inner thread fastens the base tube 43. Together, the double sided nut 49 on the proximal side and the hexagon nut 45 on the distal side secure the base tube 43 to the steel belt layer 147. In addition, the double sided nut 49 secures the spring housing 51 to the tire 36.

In operation, the base tube 43 serves as a conduit for the stud head 61 to slide through. As shown in FIG. 23, there are preferably three positions: retracted, small extension, large extension.

### Preferred Tire Manufacturing

When manufacturing the tire 36, it is preferred to weld the washers 41 to the steel belt layer 137 before adding the rubber layer 140. High strength Beryllium copper or 6061 aluminum washers FIG. 19, 41 (matching the material of the lower spring housing and the base tube for high thermal conductivity and strength with rubber/metal adhesive) are preferably glued to the steel belt layer 137 on pre-marked spots. The other face of the washer is pre-fluxed and sprayed with a thin layer of high thermal conductivity solder. Then, the tire can be wrapped with steel belt/layer per the tire designer.

The same material and coating treatment washers can then be placed over the steel belt layer 137 over the embedded washers with the solder coated face down. The washers and the steel layer can then be welded by thermal press.

The thickness of the washer 41 should match the thread size of the base tube 43. The opening of the washer 41 should equal to the matching male thread for close contact with the inserted base tube 43. The gap between the two washers should be in multiple of threading thickness, such that the base tube 43 can be thread fastened through the inserted washers 41. The inner steel belt layer 137 below the welded washer is then drilled with an opening matching the outer diameter of the base tube. The rubber layer 140 can then be added. Other layers and outer rubbers could also then be laminated and complete the hole drilling of the base.

After drilling the stud hole, the base tube 43 (FIG. 19, 43) with external (male) thread and hexagon nut 45 at one end can be inserted into the stud hole from the pavement side with metal/rubber adhesive. A base spacer 47 with a curved bottom matching the tire inner curvature and a flat top is placed over the base tube. A double side threaded nut 49 then fastens the base tube 43 and the spring housing 51 on the proximal side and the hexagon nut 45 completes the connection on the distal side.

### Filling the Oil and Testing for Leaks

To test the air portion of the air chamber of the air-to-oil booster, fill the vessel and pipe system with dyed air, and pressurize the vessel with an air pump connecting to the inlet with an air flexible tube 61 to the specified test pressure. Pressure tightness can be checked by shutting off the supply air pump and observing whether there is a pressure loss.

To test the portion of the device carrying oil, the test involves filling the oil to the vessel and pipe system 120 (oil chamber 101, circular manifold 19, lateral distribution pipes 21 and chamber 60 in the stud shaft housing 57). The air-to-oil booster's oil chamber should be equipped with two threaded outlets with removable pressurized plugs. Mount the wheel horizontally on a rotation lathe with the threaded outlets up. Connect the first outlet with a vacuum pump and connect the second outlet to an on-off valve connecting to a rubber tube that connects to an oil jar with the designed amount of oil hanging above the wheel. Close the valve connecting to the oil jar and turn on the vacuum pump to extract the air from the oil chamber 101, the pipe system 120, and chamber 60 in the stud shaft housings. Close the valve connecting the vacuum hose. Open the valve connecting to the oil jar and rotate the wheel gently until the target oil volume has been added. Remove the rubber tube and secure the pressure plug to both outlets. Pressurize the air tank to the specified pressure and setting the motorized pressure reducing valve 15 to the maximum operating pressure and observing whether there is an oil leak.

### Non Extendible Spokes

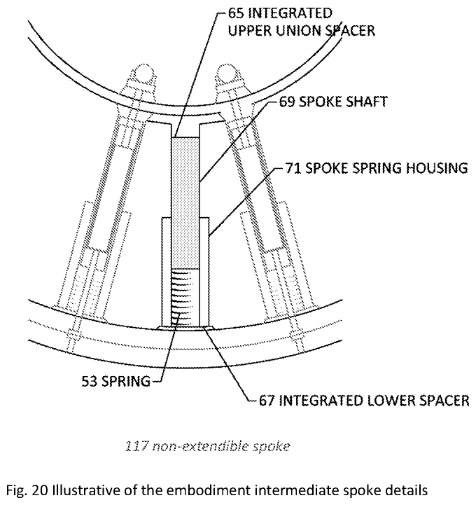

An optional embodiment employs intermediate, non-extendible spokes 117 between the extendible stud spokes 22 as shown in FIG. 20. This can result in a smoother ride. These non-extendible spokes can assist the transfer of vehicle load to the tire 36. The preferred non-extendible spoke 117 has five primary parts: (1) an integrated upper union spacer 65, (2) an integrated lower spacer 67, (3) a spoke shaft 69, (4) a spring 53, and (5) spring housing 51.

The spoke shaft 69 and the spoke spring housing 51 have same keyways and keys as the extendible stud spokes for locking the spoke shaft and the spoke spring housing. The spring 53 in the spoke spring housing 51 bias the spoke shaft 69. A vehicles' weight and the moving dynamic load exert on the spring 53 resulting a continuous smooth wheel contact with the road.

The integrated upper union spacer 65 and the adjacent outer spacer 37 should be a unibody as the spoke does not penetrate the hub. It is preferred to weld the integrated upper union spacer 65 to the adjacent outer spacer 37.

The integrated lower spacer 67 should have a hollow bottom that is fitted and adhered a rubber pad by metal-rubber glue. The integrated lower spacer 67 should be threaded to the spoke spring housing. Press the tire and the integrated lower spacer in the opposite direction and seal it with waterproof rubber cement.

### Optimized Assembly and Production

The assembly of the extendible stud to the hub and the tire can be optimized for reduction of the labor and the production time. In lieu of installing the extendible stud to the hub one at a time, the process can be greatly simplified by die casting component 1 and pre-assemble of component-2 and component-3, which the installation of the extendible stud spoke can be completed in four steps.

Component-1 includes die casting the outer spacers 37 required on half of a wheel on a thin metal sheet where the hole-openings match the spacer holes. The metal sheet is then bent to conform with the exterior of the hub with the holes of the spacers matching the holes of the hub. Component-2 includes welding inner spacer 35 and core pipe 33 to each outlet of the lateral distribution pipe 21. Component-3 includes the assembly of the extendible stud device including the stud shaft housing 57, sliding stud 55, slide stud 55, spring 53, spring housing 51, base double threaded nut 49, and base spacer 47.

The thread direction should be in the opposite directions (right hand thread and left hand thread) in order to tighten assembled parts. For instance, the thread of the stud shaft housing to the core pipe 33 and the double side threaded nut 49 to the base tube 43 must be in opposite directions such that the connections of the extendible stud device 23 to the hub and the tire can be tightened and secured. The base double side threaded nut fastens to the base tube 43 internally and the spring housing 51 externally.

The optimized assembly and production are a three-step process. The first step is to line up and adhere two pieces of component-1 to a hub. The second step is to insert component-2 from inside the hub and secure component-1 and component-2 with a nut. The third step is to fasten component-3 to the hub and the tire. The installation of component-3 is easy as the extendible stud is not pressurized that can be retracted for easy connection.

### Spring Design and Selection

The extension length of the sliding stud 55 is a result of the balance of the compression springs strength and the force applied by the fluid pressure. The air pressure reducing valve 15 regulates the air pressure to the air-to-oil pressure booster 17. The oil pressure exerts force on the proximal face of the sliding stud 55, which exerts a load to the spring based on the design spring rate.

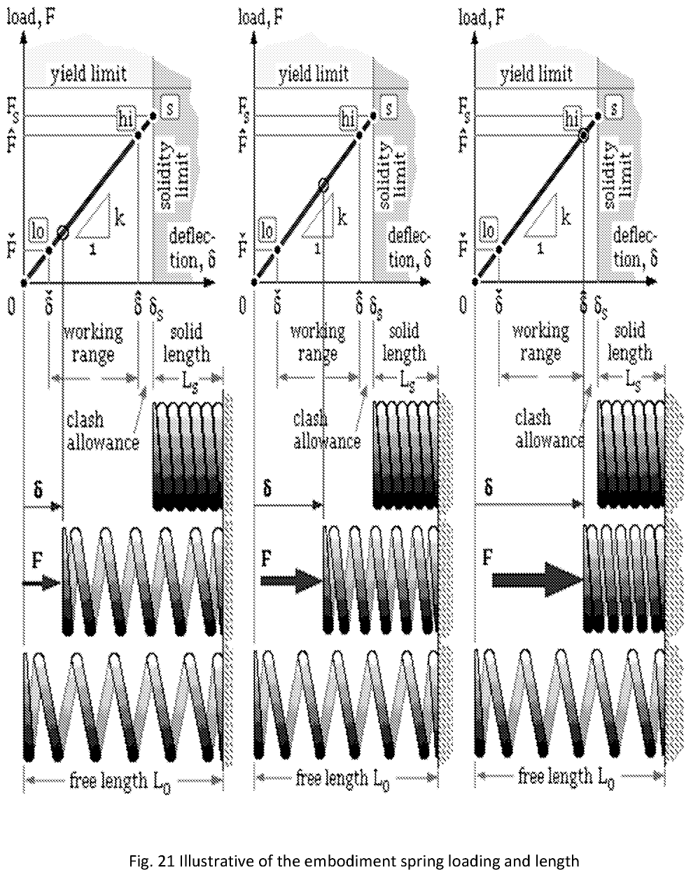

Spring rate defines the force of the compression spring. This value enables to determine how much force (pounds or newtons) it will take the spring to travel one unit of measurement (inches or millimeters). With this value, one can calculate the spring's working loads to make sure that the spring will travel down to the desired solid height under a specific load (FIG. 21, showing three different forces and the spring lengths along the spring rate slope).

### Stud Operation

The fluid (preferably oil) in the conduit system 42 puts pressure on the sliding stud 55 and moves the sliding stud 55 within the extendible stud spoke 22 to extend it to the lengths that are balanced by the forces of oil pressure and the compression spring 53.

Without the driver's activation and/or as directed by the car's traction control system, the studs should be recessed within the rubber tire by the spring 53 for smooth drive and not to damage the roadway pavement and/or the stud itself.

When the tract enhancement is activated, the extendible stud extends to two set lengths (FIG. 23). The shorter length exposes a smaller bead head that adds traction in conjunction with the ABS or for icy conditions, while the longer and larger rod is for snowy conditions.

### Continued Monitoring the Tire Wear for Optimum Stud Extrusion Length

As an optional embodiment, two proximity sensors can be installed under the chassis directly over each tire, one over the thread and one over the grooving (FIG. 5). The proximity sensors can measure tire wear. The proximity sensors are preferably powered by the vehicle's battery and are independent from the power of the stud system. The proximity sensor can communicate with the driver console by WIFI to calculate the tire wear for adjusting the length of the stud shaft extrusion by adjusting the air pressure exerting on the air-to-oil booster.

Base Tube, Stud and Tire considerations

Tires are designed with the considerations of (1) longitudinal tire force, (2) lateral (side) tire force, (3) vertical tire force, and (4) tire aligning torque in a tire design in bonded varies tire layers. A tire's composite shear strength can be as high as 6.05 MPa (878 psi) and the tensile strength can be as high as 25 MPa (3626 psi). Rubber to metal epoxy adhesive tensile strength is 30 MPa (4400 psi). Stainless steel Shear Strength is 597 MPa (86600 psi) and tensile strength is 621 MPa or 90 KSI. Beryllium copper tensile strength is 1480 MPa (215000 psi) and shear module is 50.0 GPa (7250000 psi). 6061 aluminum alloy has a tensile strength of 310 MPa (45000 psi).and Shear Strength of 207 MPa (30000 psi). The base tube 43 and the sliding stud 55 have higher shear strength and tensile strength than the tire 36, which preserves the tire strength.

A typical gasoline powered large size sedan would have 36.75 square inches of contact with the pavement per tire. Together, all four tires would have a static contact area of 147 square inches of rubber touching the road with a contact patch loading at 32 psi. The new electric car with passenger loading is approximately 5000 lbs, so the contact patch loading would be 34 PSI.

Stud head should be made of Cobalt Steel. Stud penetrating to pavement should be consistent with the asphalt cements penetration grade specified. State approved stud size is approximate 8 mm.

The diameters of the extendible stud spoke 22 and the non-extendible spoke 117 (stud shaft housing, stud shaft, and the spring housing) and its driving mechanics behaviors along with the tire composition and strength can be simulated by a dynamic model.

### Stud and Spring Adjusted Tire Patch on Pavement

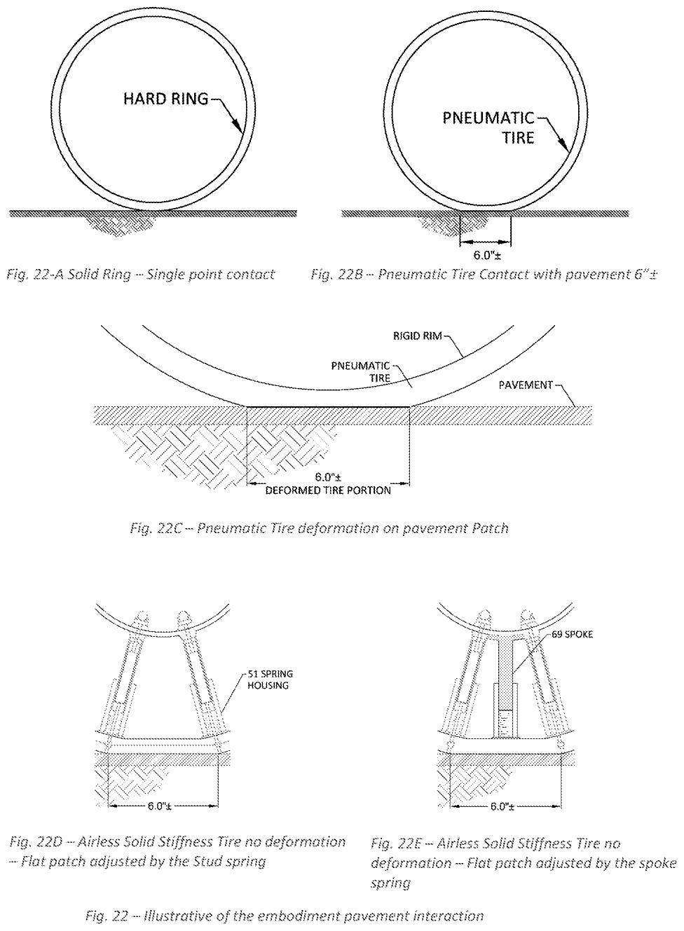

FIG. 22A illustrates a solid ring on a pavement with one single contact point. FIG. 22B illustrates a pneumatic tire on a pavement with 6±inch pavement contact patch. FIG. 22C illustrates the deformation of a pneumatic tire of the contact patch, a result of air being compressed.

FIGS. 22D and 22 E illustrate how the embodiments disclosed in this specification react to similar pavement conditions. The deformation of the wheel 10 performs similarly to that of a prior art pneumatic tire.

The independent spring would settle and balance smoothly upon the total load (dead and dynamic) on the contact surface.

### Thermal Dissipation

The dominant modes of heat exchange to and from a tire are: (1) Convective heat loss to surrounding air, (2) Conductive heat loss to the road, (3) Conductive heat transfer to the wheel, and (4) Radiative heat loss

Most of a tire's heat is lost at the tire-road and tire-air (external) interfaces. After running a while, the tire is hotter than the ambient, heat is lost in the tire-road interface from conduction into the ground, and at the tire-air interface from forced convection with the ambient air. Heat losses from radiation are often ignored.

Given the significant heat losses at the tire-road interface and transient heat generated at the surface (surface heat generation is highly dependent on slip ratio, slip angle, and load), a tire's surface temperature fluctuates rapidly with dynamic loading. Conversely, the inner liner is well insulated, provided the heat transfer is via natural convection, versus forced convection and conduction to the outer surface. As a result, the quasi steady state core and inner liner temperature will typically be higher than the average surface temperature and change at a much slower rate.

The invention transfers the inner heat to the wheel-tire interface; and dissipate the heat at the rim by conductive heat transfer, which the rubber has a thermal conductivity of 0.5 W/MK, the steel belt in the tire core has a thermal conductivity of 15 W/MK, Beryllium copper and 6061 aluminums have a thermal conductivity around 150 W/MK. Inner tire heat is collected and transferred to the spoke and the rim and is convectively cooled to ambient air. The air compressor once filled the air tank pressure, the air is then replacing the hotter air of the covered rim with cooler ambient air.

### Wheel Balance

An unbalanced wheel would cause vibration. Tire balance describes the distribution of mass within an automobile tire or the entire wheel (including the rim) on which it is mounted. When the wheel rotates, asymmetries in its mass distribution may cause it to apply periodic forces and torques to the axle, which can cause ride disturbances, usually as vertical and lateral vibrations, and this may also cause the steering wheel to oscillate. The frequency and magnitude of this ride disturbance usually increase with speed, and vehicle suspensions may become excited when the rotating frequency of the wheel equals the resonant frequency of the suspension.

The pipe system 120 and the extendible stud spokes are symmetric, any minor weight deviation can be balanced by the addition of adhesive weights. The mechanical spacer has a symmetric layout. The materials and dimensions of the four compartment insertions should be designed with static weight balance.

### Preferred Material Specifications

The hub adaptors, core pipes, and the stud shaft and housing should have strength like class 304 stainless steel or better. The stud shaft base, including tube, washer, nuts and spring housing should be high thermal conductivity, high strength Beryllium copper or 6061 aluminums. All fasteners should be lockable or with liquid lock. All connections should be class IP67. Washers for all moving parts should have dynamic O-ring and all joints should have pressure grades meeting the design.

### Benefits

Shorter stopping distance—In braking situations where the wheels on a non-ABS equipped vehicle would lock up, ABS will generally provide shorter controlled stopping distance. On some surfaces such as gravel or a skim of snow, ABS braking distance can be longer. The invention increases wheel traction and provide shorter controlled stopping distance regardless of the surface condition.

Reduction on waste and greenhouse effect—Approximate 1.8 billion used tires disposed worldwide each year. Approximately half of all waste tires are burned. Burning tires pumps millions of tons of greenhouse gases and toxins into our atmosphere.

Easy retread for cost reduction—Retread tires are to replace the worn tread on used tires with new tread to help extend the life of the tire.

Lesser road hazard—around 12 percent of tires are lost annually due to blowout issues, an airless tire with the invention eliminates blow out hazard.

Low maintenance—Doesn't require regular air pressure maintenance and drivers won't have to worry about flat tires. The onboard computer and sensor would notify a check and/or maintenance is required, including whether the tires need to be rotated.

No need of a spare tire—It eliminates the need of a spare tire. Hence, no increase on total tire weight

What is claimed is:

1. A wheel for enhanced traction, the wheel comprising
a center hub, the center hub comprising a pressure generating assembly and a center hub face,
an extendible stud spoke, the extendible stud spoke connected to the center hub face and emanating radially from the center hub face, a proximal end of the extendible stud spoke in fluid communication with the pressure generating assembly, the extendible stud spoke comprising a sliding stud, and
a tire connected to a distal end of the extendible stud spoke.

2. The wheel of claim 1 comprising a non-extendible spoke.

3. The wheel of claim 1, the pressure generating assembly comprising
an air tank in fluid communication with the proximal end of the extendible stud spoke via a conduit system.

4. The wheel of claim 3, the conduit system comprising,
a motorized valve,
a pressure reducing valve, and
an air to oil pressure booster,
wherein the motorized valve, pressure reducing valve and air to oil pressure booster are connected to the conduit system between the pressurized air tank and the extendible stud spoke.

5. The wheel of claim 3, the conduit system comprising
a circular distribution manifold connected to a lateral distribution pipe, and
the lateral distribution pipe connected to the proximal end of the stud spoke.

6. The wheel of claim 3, the pressure generating assembly further comprising an air compressor connected to the air tank.

7. The wheel of claim 3, the pressure generating assembly further comprising a generator.

8. The wheel of claim 1, the extendible stud spoke comprising a stud shaft housing and a slidable stud positioned within the stud shaft housing.

9. The wheel of claim 8, the extendible stud spoke further comprising a spring biasing the extendible stud into a retracted position.

10. The wheel of claim 8, the extendible stud comprising a face in fluid communication with the pressure generating assembly wherein pressure from the pressure generating assembly biases the sliding stud into an extended position.

11. The wheel of claim 10, wherein when the sliding stud is in the extended position, a distal end of the sliding stud extends past an outside face of the tire.

12. The wheel of claim 2, the non-extendible spoke comprising
a spoke slidably positioned inside a spring housing and
a spoke spring positioned inside the spring housing biasing the spoke toward the center hub.
